(19) United States
(12) Patent Application Publication
(10) Pub. No.: US 2016/0199874 A1
(43) Pub. Date: Jul. 14, 2016

(54) ANTI-CORROSION PEELABLE COATING AND SPRAYER FOR APPLYING THE SAME

(71) Applicant: Caterpillar Inc., Peoria, IL (US)

(72) Inventors: John M. Spangler, Peoria, IL (US); Anca I. Marcu, Peoria, IL (US); Brent W. Skinner, Pekin, IL (US); Salwa (SUE) B. Zoghbi, Edwards, IL (US); Anthony C. Price, Morrisonville, IL (US)

(73) Assignee: Caterpillar Inc., Peoria, IL (US)

(21) Appl. No.: 15/079,245

(22) Filed: Mar. 24, 2016

(51) Int. Cl. B05D 1/02

(52) U.S. Cl. CPC B05D 1/02

(57) ABSTRACT

A method for applying a coating material on a surface having a first portion and a second portion is disclosed. The method includes spraying the coating material on the surface using a non-regulated pressurized sprayer at a predetermined pressure. The sprayer including a nozzle having an orifice, a body, a closure, and a dip tube. The coating material is an anti-corrosion peelable coating having a predetermined composition. The coating material on the first portion of the surface is retained, and the coating material on the second portion of the surface is peeled off.

### TECHNICAL FIELD

The present disclosure relates to a peelable coating applied on surfaces, and more specifically, to an anti-corrosion peelable coating applied on the surfaces using sprayers.

### BACKGROUND

Coatings are applied onto surfaces of various devices such as vehicles, crossover tubes and liftarm tubes of heavy machines etc., for providing protection from various damages such as, but not limited to, acid rain, abrasive particles, and corrosion. For example, corrosion is a byproduct of an undesirable chemical reaction when a material such as a metal having machined and/or painted surfaces is exposed to the environment. Exposure of the metal to water or water vapor causes oxidation of the metal or formation of rust, and thus causes unsightly rust spots on a surface of the material.

Currently, the coatings such as paints and some rust preventatives etc. are utilized to prevent the corrosion. The coatings are applied on the surfaces of the various devices using fluid or air pressure spray equipments such as, but not limited to, airless spray equipment, and air assisted airless spray equipment, to atomize coating. The atomize coating allows the coating to flow well on the surfaces of the various devices. However, the use of the various spray equipments drives deployment of heavy mechanical devices, and thus makes entire spray process complicated and costly. Further, an effective atomization generally requires pumps, air, or other devices to increase the pressure above 30 psi consistently. Unfortunately it is this type of spray equipments that make the entire spray process more complex and less portable. Therefore, there is a need for a process for applying an anti-corrosion peelable coating using a sprayer which is a cost effective, and eliminates need of the heavy mechanical devices.

### SUMMARY OF THE DISCLOSURE

In one aspect of the present disclosure, a method for applying a coating material on a surface having a first portion and a second portion is provided. The method includes spraying the coating material on the surface using a non-regulated pressurized sprayer at a predetermined pressure. The sprayer including a nozzle having an orifice, a body, a closure, and a dip tube. The coating material is an anti-corrosion peelable coating having a predetermined composition. The coating material on the first portion of the surface is retained, and the coating material on the second portion of the surface is peeled off.

Other features and aspects of this disclosure will be apparent from the following description and the accompanying drawings.

### BRIEF DESCRIPTION OF THE DRAWINGS

FIG. 1 illustrates a pictorial view of a heavy machine showing an exploded view of hose assemblies which are coupled with each other, in accordance with the concepts of the present disclosure;

FIG. 2 is a side view of a sprayer (i.e., a hand pump sprayer) for applying an anti-corrosion peelable coating, in accordance with the concepts of the present disclosure;

FIG. 3 is a side sectional view of a portion of the sprayer (i.e., the hand pump sprayer) of FIG. 2 for applying the anti-corrosion peelable coating, in accordance with the concepts of the present disclosure; and

FIG. 4 is a side sectional view of an alternate embodiment of a portion of a sprayer (i.e., a fan sprayer) for applying the anti-corrosion peelable coating, in accordance with the concepts of the present disclosure.

### DETAILED DESCRIPTION

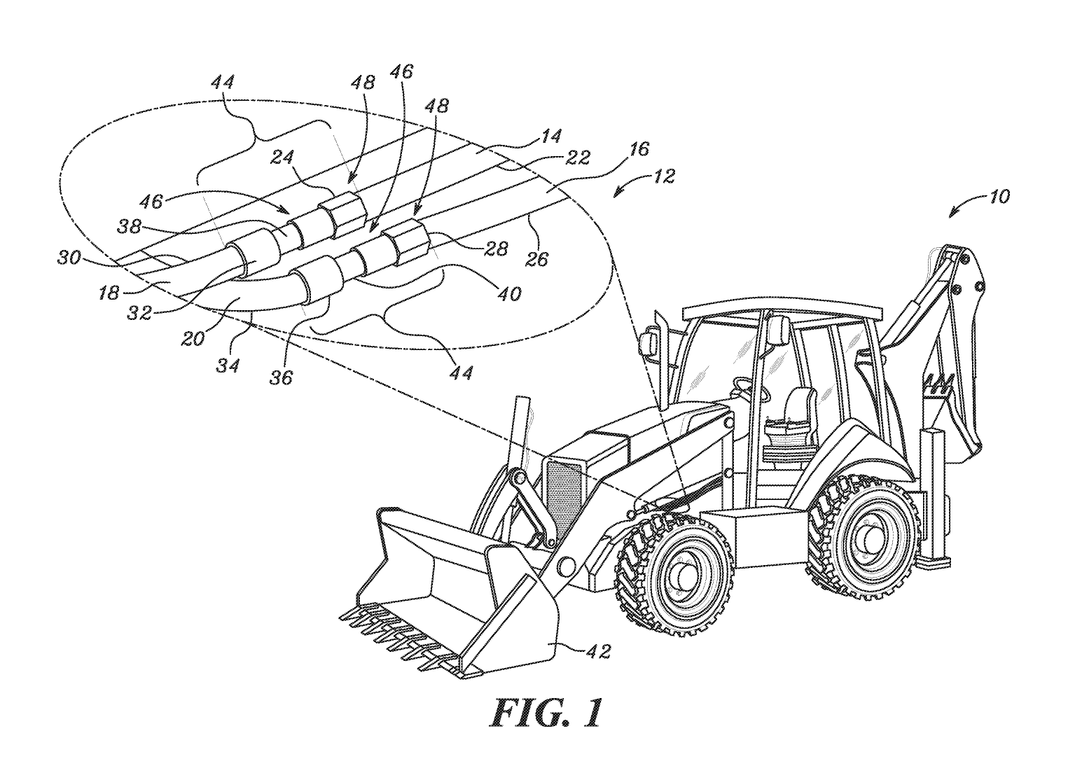

Referring to FIG. 1, a heavy machine 10 showing an exploded view of hose assemblies 12 which are coupled with each other is disclosed. The heavy machine 10 includes the hose assemblies 12 having a first hose assembly 14, a second hose assembly 16, a third hose assembly 18, and a fourth hose assembly 20. The first hose assembly 14 having a first hose 22 and a first connector 24. The second hose assembly 16 having a second hose 26 and a second connector 28. Similarly, the third hose assembly 18 having a third hose 30 and a third connector 32. The fourth hose assembly 20 having a fourth hose 34 and a fourth connector 36. The first connector 24 of the first hose assembly 14 is connected with the third connector 32 of the third hose assembly 18 through a first adapter 38. Similarly, the second connector 28 of the second hose assembly 16 is connected with the fourth connector 36 of the fourth hose assembly 20 through a second adapter 40. The first connector 24, the second connector 28, the third connector 32, and the fourth connector 36, are two-end connectors, and are also referred as hose fittings. The heavy machine 10 further includes various other components such as, but not limited to, wheels, an operator's cabin, boom, engine, or rim. For the purpose of simplicity, the various other components of the heavy machine 10 are not labeled in FIG. 1. It should be noted that the heavy machine 10 mentioned above has been provided only for illustration purposes, without departing from the scope of the disclosure.

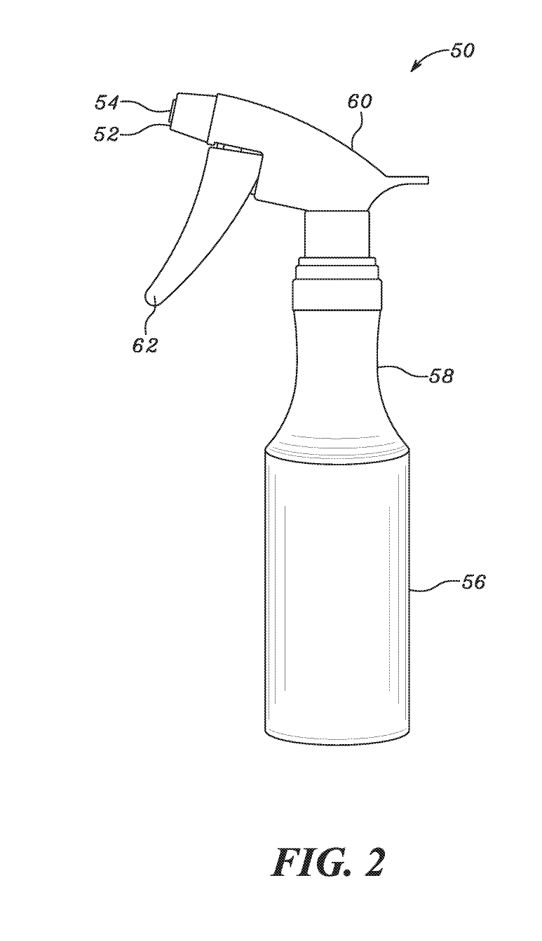

The hose assemblies 12 are utilized to carry fluid (i.e., hydraulic fluid) to operate a bucket 42 of the heavy machine 10 (i.e., the hose assemblies 12 are those through which the fluid (i.e., the hydraulic fluid) flows). When the hose assemblies 12 are exposed to environment, a surface 44 of each one of the first adapter 38, the second adapter 40, the first connector 24, the second connector 28, the third connector 32, and the fourth connector 36, suffers from corrosion. In order to prevent the corrosion of the surface 44, it is sprayed with a coating material using a sprayer (not shown) which may be a non-regulated pressurized sprayer. The detailed description of the sprayer is described later in conjunction with FIGS. 2, 3, and 4. It will be apparent to one skilled in the art that the surface 44 of the hose assemblies 12 of the heavy machine 10 mentioned-above has been provided only for illustration purposes. Alternatively, the surface 44 of some other devices such as machined parts, plated parts, painted parts, fasteners, vehicles etc., may be utilized, without departing from the scope of the disclosure. The surface 44 is a metal surface such as, but not limited to, iron, steel, alloys of iron, or alloys of steel.

The coating material is an anti-corrosion peelable coating having a predetermined composition, which is applied onto the surface 44 using the sprayer (not shown) for a predetermined period of time. The surface 44 having a first portion 46 and a second portion 48. The first portion 46 of the surface 44 corresponds to a desired portion of the surface 44, and the second portion 48 of the surface 44 corresponds to an undesired portion of the surface 44. It should be noted that the coating material applied on the first portion 46 of the surface 44 is retained, and the coating material applied on the second portion 48 of the surface 44 may be peeled off. Alternatively, the coating material applied on the first portion 46 of the surface 44 and the second portion 48 of the surface 44, is retained, without departing from the scope of the disclosure.

In an example, the coating material is a water-based film, and an oil-based VCI (i.e., oil-based volatile corrosion inhibitors). In a first case, the water-based film is applied on top of a layer of the oil-based VCI that is applied on the surface 44. In a second case, the oil-based VCI is mixed in with the water-based film, and is then applied on a top of the surface 44. In a third case, the oil-based VCI is applied on top of a layer of the water-based film that is applied onto the surface 44 for the predetermined period of time. The predetermined period of time allows the water-based film to set or cure. Alternatively, any value of time for the water-based film to set or cure is used such as, but not limited to, for about 1-12 hours, 1-36 hours, or 20-36 hours. Examples of the coating material constituents such as, but not limited to, cellulose, vinyl chloride, acrylic, colloidal acrylic dispersions, polyurethane dispersions, polyethylene, natural or synthetic latexes, acrylic resins, acrylic copolymers such as styrene-acrylates, butadiene-acrylates, vinyl chloride-acrylates, polyvinylidene chloride-acrylates, vinyl acetate-acrylates, polyvinyl-styrene butadiene copolymers, polyvinyl butyrals, polyisocyanates, polycondensate type aliphatic polyurethanes such as anionic, cationic, non-ionic or amphoteric polyurethanes, acrylic polyurethanes, polyester-polyurethanes, or mixtures thereof.

The water-based film having various compositions. For example, in a first composition, the water-based film having various components such as, but not limited to, water (distilled, filtered, or tap) between about 40% to 70% by weight, polyacrylate between about 30% to 60% by weight, and carboxylic acid amine salt between about 0.05% to 10% by weight. In a second composition, the water-based film having a composition such as a blend of non-volatile components having about 41-71% by weight of coating composition, about 30-60% by weight the coating material component, about 6-17% by weight release aids, about 0.1-0.9% by weight wetting aids, about 0.1-0.9% by weight defoamer, about 0.1-0.9% by weight dispersing aids, and about 1-7% by weight thickeners, a strippable coating composition includes about 20-56% by weight of coating composition of volatile components, about 0.1-2.9% by weight plasticizers and coalescents, and about 26.0-60% by weight of water. On the other hand, the oil-based VCI includes, but not limited to, Daubert NOX Rust 1100, Chemtool VCI-F, RustX 400AEX, Cortec VpCI 322, and Cortec VpCI 705. It should be noted that the oil-based VCI is brushed, sprayed, dipped, fogged, sprinkled, mixed, poured, and rolled on to, under or mixed in with the water-based film.

It will be apparent to one skilled in the art that the coating material i.e., the water-based film and the oil-based VCI mentioned above has been provided only for illustration purposes. The coating material such as an emulsion acrylic copolymer which has 0 to 4 wt % ethylenically unsaturated acid (or salts thereof) monomer based on dry weight of copolymer acid groups form acidic monomers, 0 to 4 wt % of (meth) acrylamide monomer based on a dry weight of the emulsion acrylic copolymer, a linear temperature of up to 30° C., and an average particle size of 30 to 1000 nm, is utilized as the anti-corrosion peelable coating for applying on the surface 44 (i.e., the first portion 46 and the second portion 48), without departing from the scope of the disclosure. It should be noted that the emulsion acrylic copolymer having a thickness of greater than 1 mil and less than 6 mil, and a viscosity (i.e., determined in a laboratory) of greater than 22 seconds on a number 2 Zahn cup to atomize viscous polymeric material.

In another coating material (i.e., the emulsion acrylic copolymer) mentioned herein having a glass transition temperature (“Tg”) of below about 90° C. it should be noted that the Tg used herein is calculated by using Gordon and Taylor equation. The Tg of monomers M1 and M2 is calculated by using following equation:

w(M1)×Tg(M1)+k×w(M2)×Tg(M2)

Tg(calc.)=w(M1)+k×w(M2)

Wherein,

Tg(calc.) is the glass transition temperature calculated for the emulsion acrylic copolymer,

w(M1) is a weight fraction of monomer M1 in the emulsion acrylic copolymer,

w(M2) is a weight fraction of monomer M2 in the emulsion acrylic copolymer,

Tg(M1) is the glass transition temperature of the homopolymer of M1, and

Tg(M2) is the glass transition temperature of the homopolymer of M2,

k is a fitted constant, with all temperatures expressed in K. When k=1, a linear relationship results:

Tg(calc.)=w(M1)×Tg(M1)+w(M2)×Tg(M2).

Further, a term “wt %” corresponds to a number of parts by weight of ingredient per 100 parts by weight of the composition or material of which the ingredient forms a part. Further, a term “aqueous medium” refers to a composition containing a substantial amount of water. The aqueous medium contains other ingredients as well. Further, the terms such as a “film” or a “coating” refer to three dimensional shapes that are useful as a protective and/or decorative barriers or layers. The film or the coating is characterized as having one relatively small dimension, for example, thickness, and two relatively large dimensions such as length and width, especially when formed using a coating process such as brushing, rolling, or spraying. The terms film and coating are also referred to other thicker protective and/or decorative barriers or layers such as caulks, or sealants. The term “copolymer” is used herein to refer to a polymer derived from two or more different monomers, and is used to refer to terpolymers. The copolymer having a linear Tg of −30 to 30° C., or −5 to 20° C., or 0 to 15° C. Further, the emulsion acrylic copolymer having a Tg of 0 to 7.5° C., and a particle size of 120 to 700 nm, or 120 to 200 nm.

Further, the expression such as “(meth)”, “(alk)”, or “(alkyl)”, is used to indicate that a particular substituent in a chemical name is optionally present but may be absent. For example, the term “(meth)acrylate” is used to refer to either acrylate or methacrylate. Alternatively, the emulsion acrylic copolymer contains a crosslinker monomer, the emulsion acrylic copolymer having a Tg of −30 to 30° C., or −5 to 20° C., or 0 to 18° C. Also, the particle size of the emulsion acrylic copolymer containing the crosslinker monomer of 80 to 700 nm, or 120 to 700 nm, or 80 to 200 nm, or 120 nm to 200 nm.

It will be apparent to one skilled in the art that above-mentioned composition of the emulsion acrylic copolymer has been provided only for illustration proposes. The other coating composition of the emulsion acrylic copolymer may be used such as, but not limited to, 0.0001 to 4 wt ethylenically unsaturated acid (or salts thereof) monomer based on the dry weight of the copolymer acid groups form acidic monomers, and 0 to 4 wt % of (meth)acrylamide monomer based on the dry weight of the copolymer, or 0 to 4 wt % or 0.0001 to 4 wt % ethylenically unsaturated acid (or salts thereof) monomer based on the dry weight of the copolymer acid groups form acidic monomers, and 0 to 3 wt %, or 0 to 2 wt % of (meth)acrylamide monomer based on the dry weight of the emulsion acrylic copolymer, without departing from the scope of the disclosure.

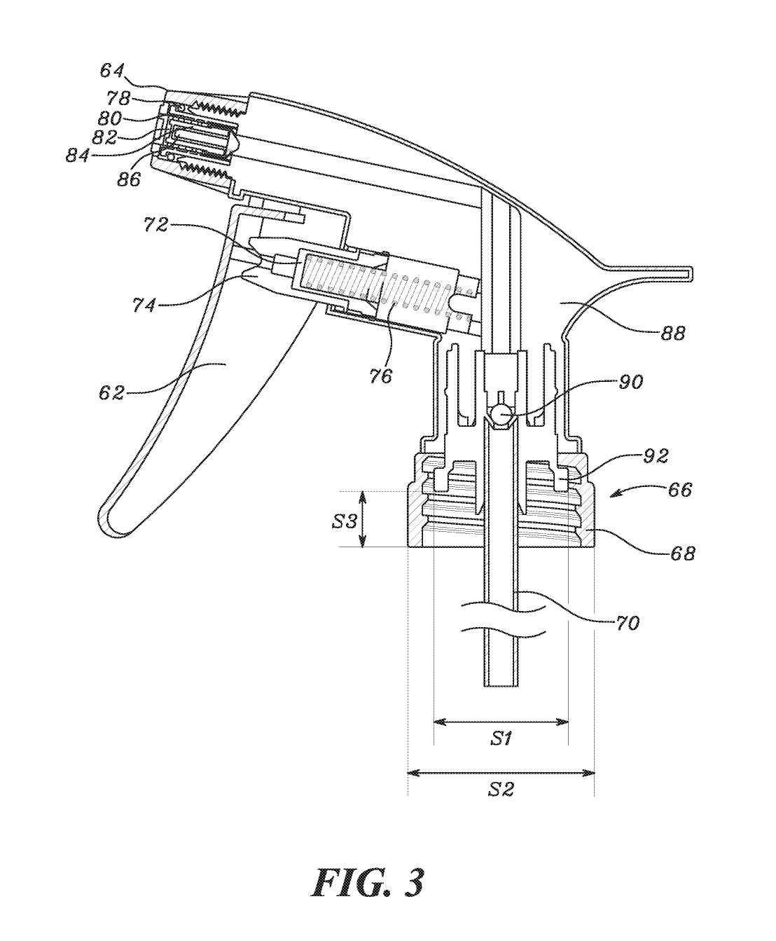

Referring to FIGS. 2, and 3, a sprayer 50 (i.e., a hand pump sprayer) utilized for spraying the coating material (i.e., the anti-corrosion peelable coating) on the surface 44 (shown in FIG. 1). The sprayer 50 (i.e., the hand pump sprayer) includes various components such as a nozzle 52 (shown in FIG. 2) having an orifice 54 (shown in FIG. 2), a reservoir 56, a neck 58 (shown in FIG. 2), a housing 60 (shown in FIG. 2), a trigger 62, a nozzle cap 64, a spray engine 66 (shown in FIG. 3), a closure 68, a dip tube 70, a piston 72, a piston base 74, a spring 76, an O-ring 78, a collar 80, a spin 82, a spring 84, a second valve 86, a body 88, a ball valve 90, and an intake 92.

The sprayer 50 includes the reservoir 56 (shown in FIG. 2) and the neck 58 (shown in FIG. 2) which are suitable for holding the coating material. Further; the sprayer 50 includes the spray engine 66 (shown in FIG. 3) which is operated by the trigger 62, and is enclosed within the housing 60 (shown in FIG. 2). The spray engine 66 is utilized for various sizes and designs of the reservoir 56. Further, the sprayer 50 having the closure 68 which is of size such as 28/400 mm. The size of the closure 68 is represented as a first closure size S1, a second closure size S2, and a third closure size S3 having values 25.3+/−0.05 mm, 28+/−0.05 mm, and 9.5 mm respectively. It should be noted that the first closure size S1, and the second closure size S2, are diameters, and the third closure size S3 is length. The sprayer 50 further has the ball valve 90 which is utilized to prevent downward movement of the coating material, the intake 92 which has an opening to assist fluid (i.e., the coating material) movement.

The sprayer 50 further includes the dip tube 70 (shown in FIG. 3) through which the coating material is drawn upwardly, in response to actuation by the trigger 62. Based on the actuation of the trigger 62 through its stroke causes corresponding movement of the piston 72. The movement of the piston 72 having the piston base 74, pumps the coating material from the reservoir 56, through a flow path and out of the nozzle 52 (shown in FIG. 2). The sprayer 50 includes the nozzle 52 having the orifice 54, which is utilized for dispensing the coating material from the sprayer 50 at a predetermined pressure. The predetermined pressure with respect to the sprayer 50 is 30 psi or more than 30 psi. The nozzle 52 of the sprayer 50 is covered with the nozzle cap 64 which is utilized to change flow and spray pattern of the coating material being sprayed (shown in FIG. 3), and a size of the orifice 54 with respect to the sprayer 50 is in a range between 0.009 inch to 0.39 inch. The sprayer 50 having the second valve 86 which is utilized to allow the coating material to pass.

The sprayer 50 further includes various components such as the spin 82 which is utilized to control the flow of the liquid (i.e., the coating material) to the nozzle 52, the collar 80 which is utilized to contain the spin 82 into its proper location, and the O-ring 78 which allows the collar 80 to fit snug into the body 88. Additionally, the sprayer 50 includes the spring 76 which provides bias to urge the trigger 62 back to a forward position at the end of the stroke, and the spring 84. It should be noted that the sprayer 50 (i.e., the hand pump sprayer) mentioned herein having an output per stroke of 1.4 cc+/−0.11 cc, a durability of over 5000 times, and a weight of 31 G+/−0.5 G. The various components of the sprayer 50 mentioned above are made up of various materials, which are illustrated in table 1.

TABLE 1

| Components of Sprayer | Material |
|---|---|
| Nozzle Cap | Polypropylene (PP) |
| O-ring | Nitrile-butadiene rubber (NBR) |
| Collar | Polypropylene (PP) |
| Spin | High-density polyethylene (HDPE) |
| Spring | SS#304 |
| Second valve | High-density polyethylene (HDPE) |
| Piston | Nitrile-butadiene rubber (NBR) |
| Piston Base | Polypropylene (PP) |
| Trigger | Polypropylene (PP) |
| Spring | SS#304 |
| Body | Polypropylene (PP) |
| Ball valve | SS#316 |
| Intake | Polypropylene (PP) |
| Closure | Polypropylene (PP) |
| Dip tube | High-density polyethylene (HDPE) |

As shown in Table 1, the various components of the sprayer 50 are made up from various materials. For example, the components such as the trigger 62, the nozzle cap 64, the closure 68, the piston base 74, the collar 80, the body 88, and the intake 92, are made up from the polypropylene (PP) material. Similarly, the components such as the piston 72, and the O-ring 78, are made up from the nitrile-butadiene rubber (NBR) material. Similarly, the components such as the dip tube 70, the spin 82, and the second valve 86, are made up from the high-density polyethylene (HDPE) material. Similarly, the spring 76 and the spring 84 are made up from SS#304 (i.e., 304 stainless steel). The 304 stainless steel includes elements by percentage by weight-maximum unless range i.e., C=0.08/Mn=2.00/P=0.045/S=0.030/Si=1.00/Cr=18.00-20.00/Ni=8.00-12.00/N=0.10. Similarly, the ball valve 90 is made up from SS#316 (i.e., 316 stainless steel). The 316 stainless steel includes elements by percentage by weight-maximum unless range i.e., C=0.08/Mn=2.00/P=0.04/S=0.03/Si=1.00/Cr=16.00-18.00/Ni=10.00-14.00/Mo=2.00-3.00. It should be noted that the materials mentioned above for the various components of the sprayer 50 have been provided only for illustration purposes. The components of the sprayer 50 may be manufactured from some other material as well, without departing from the scope of the disclosure.

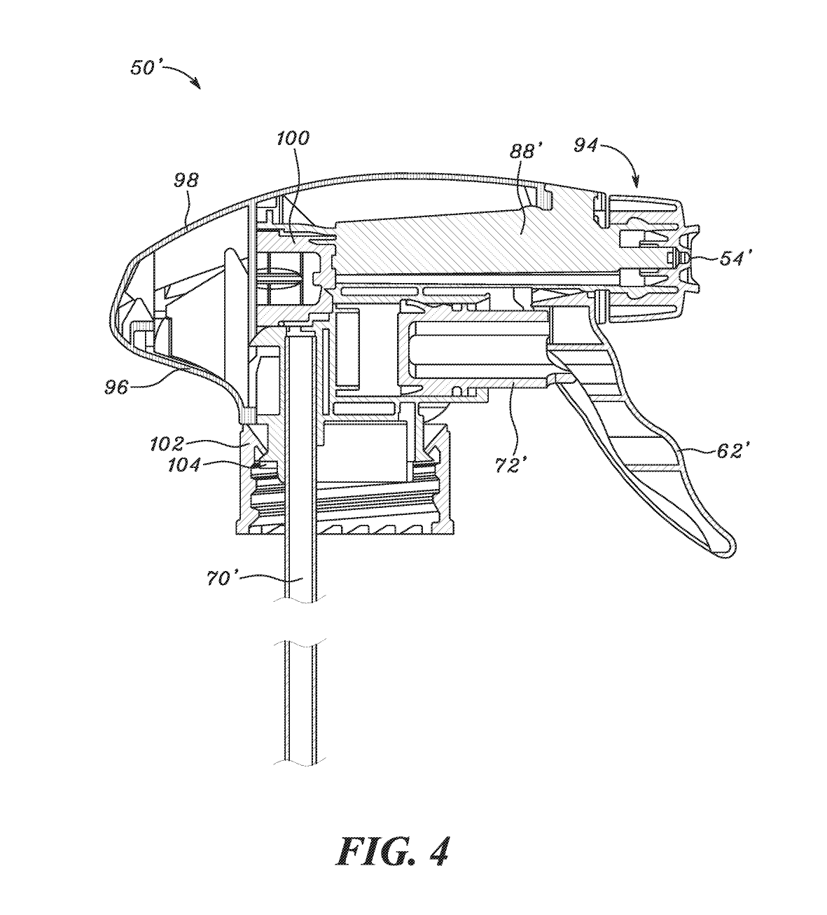

Referring to FIG. 4, a sprayer 50′ (i.e., a fan sprayer) is utilized for spraying the coating material (i.e., the anti-corrosion peelable coating) on the surface 44 (shown in FIG. 1). The sprayer 50′ (i.e., the fan sprayer) having various components such as an orifice 54′, a trigger 62′, a dip tube 70′, a piston 72′, a body 88′, a fan nozzle 94 (i.e., an index cap) that can be orientated both horizontally and vertically, a lower shroud 96, an upper shroud 98, a dome valve 100, a screw cap 102, and a gasket 104. It should be noted that the sprayer 50′ is a precompression trigger type sprayer.

The sprayer 50′ having the lower shroud 96 and the upper shroud 98 which are assembled together over a housing (not shown) of the sprayer 50′ solely by mechanical attachments of shroud pieces to each other, and to the housing (not shown) of the sprayer 50′. Further, the sprayer 50′ having the screw cap 102 which is utilized to connect the sprayer 50′ (i.e., the fan sprayer) to a bottle that contains the liquid (i.e., the coating material), the body 88′, and the gasket 104 which is used for sealing. The sprayer 50′ further includes the dip tube 70′ through which the coating material flows, in response to actuation by the trigger 62′. Based on the actuation of the trigger 62′ through its stroke causes corresponding movement of the piston 72′. Thereafter, the sprayer 50′ includes the fan nozzle 94 having the orifice 54′, which is utilized for dispensing the coating material from the sprayer 50′ at a predetermined pressure. The predetermined pressure with respect to the sprayer 50′ is 30 psi or more than 30 psi, and a size of the orifice 54′ with respect to the sprayer 50′ are in the range of 0.009 inch to 0.039 inch. The sprayer 50′ further having the dome valve 100 which is utilized to allow the coating material to pass at the predetermined pressure.

The various components of the sprayer 50′ mentioned above are made up of various materials, which are illustrated in table 2.

TABLE 2

| Components of Sprayer | Material |
|---|---|
| Body | Polypropylene (PP) |
| Piston | Polyethylene (PE) |
| Dome valve | Polyethylene (PE) |
| Trigger | Polypropylene (PP) |
| Fan nozzle | Polypropylene (PP) |
| Lower shroud | Polypropylene (PP) |
| Upper shroud | Polypropylene (PP) |
| Screw cap | Polypropylene (PP) |
| Gasket | Tri-seal |
| Dip tube | Polypropylene (PP) |

As shown in Table 1, the various components of the sprayer 50′ are made up from various materials. For example, the components such as the body 88′, the trigger 62′, the fan nozzle 94, the lower shroud 96, the upper shroud 98, the screw cap 102, and the dip tube 70′, are made up from the polypropylene (PP) material. Similarly, the components such as the piston 72′, and the dome valve 100, are made up from the polyethylene (PE) material. It should be noted that the materials mentioned above for the various components of the sprayer 50′ have been provided only for illustration purposes. The components of the sprayer 50′ may be manufactured from some other material as well, without departing from the scope of the disclosure.

It will be apparent to one skilled in the art that the sprayer 50 and the sprayer 50′ mentioned above have been provided only for illustration purposes. A bug sprayer is a non-regulated pressurized sprayer, and other pre-compression trigger type sprayer may also be utilized for applying the anti-corrosion peelable coating on the surface 44 (i.e., the first portion 46 and the second portion 48), without departing from the scope of the disclosure.

### INDUSTRIAL APPLICABILITY

The present disclosure provides a method for applying the coating material on the surface 44. The method discloses spraying the coating material (i.e., the anti-corrosion peelable coating) on the surface 44 (i.e., the first portion 46 and the second portion 48) using the sprayer 50 (i.e., the hand pump sprayer), and the sprayer 50′ (i.e., the fan sprayer) at the predetermined pressure. The coating material (i.e., the anti-corrosion peelable coating) acts as inhibitors or barriers that protect the surface 44 (i.e., the first portion 46 and the second portion 48) from the corrosion. Further, the method discloses that the coating material sprayed on the first portion 46 of the surface 44 is retained, and the coating material sprayed on the second portion 48 of the surface 44 may be peeled off. Thus, such type of the coating material is easily removed in some locations, when dried, and therefore allows easy manipulation of the surface 44 with some other coating material. Further, the sprayer 50 (i.e., the hand pump sprayer), and the sprayer 50′ (i.e., the fan sprayer) does not requires mechanical collection devices, and high spray equipments, and thus results in improving total application cost. Also, such type of the method for spraying the coating material on the surface 44, does not require fully atomize coating, and thus promotes a more safe application in terms of protecting the surface 44 from the corrosion.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for applying a coating material on a surface having a first portion and a second portion, the method comprising:
spraying the coating material on the surface using a non-regulated pressurized sprayer at a predetermined pressure, the sprayer including:
a nozzle having an orifice;
a body;
a closure; and
a dip tube;
wherein the coating material is an anti-corrosion peelable coating having a predetermined composition; and
wherein the coating material on the first portion of the surface is retained, and the coating material on the second portion of the surface is peeled off.
